(19) United States
(12) Patent Application Publication
(10) Pub. No.: US 2026/0195073 A1
(43) Pub. Date: Jul. 9, 2026

(54) MEMORY SYSTEM AND CONTROLLER THEREOF

(71) Applicant: SK hynix Inc., Icheon-si Gyeonggi-do (KR)

(72) Inventor: Ki Cheol SON, Icheon-si Gyeonggi-do (KR)

(73) Assignee: SK hynix Inc., Icheon-si Gyeonggi-do (KR)

(21) Appl. No.: 19/420,226

(22) Filed: Dec. 15, 2025

(30) Foreign Application Priority Data
Jan. 6, 2025 (KR) 10-2025-0001505

(51) Int. Cl. G06F 3/06

(52) U.S. Cl. CPC G06F 3/0659; G06F 3/0604; G06F 3/0679

(57) ABSTRACT

A memory system according to an embodiment of the present disclosure includes a memory device including a plurality of planes of a first type and a plurality of planes of a second type, wherein each of the plurality of planes of the first type and each of the plurality of planes of the second type of plane include a plurality of main blocks and an extra block; and a controller configured to control a first extra block to perform an operation command, wherein the plurality of planes of the first type includes the first extra block to which the block address is allocated and the plurality of planes of the second type of plane includes a second extra block to which a block address is not allocated.

### CROSS REFERENCE TO RELATED APPLICATION

The present application claims priority under 35 U.S.C. §119(a) to Korean patent application number 10-2025-0001505 filed on January 6, 2025, in the Korean Intellectual Property Office, the entire contents of which application is incorporated herein by reference.

### BACKGROUND

### 1. Technical Field

The present disclosure relates to an electronic device, including but not limited to a memory system and a controller of the memory system.

### 2. Related Art

A typical memory device includes a plurality of planes, each of which includes a plurality of memory blocks that store data.

The plurality of memory blocks includes main blocks that storing user data and extra blocks that store system information.

To increase memory capacity, the quantity of planes in the memory device is increased, and both the quantity of main blocks and the quantity of extra blocks is increased.

### SUMMARY

A memory system according to an embodiment of the present disclosure may include: a memory device including a plurality of planes of a first type and a plurality of planes of a second type, wherein each of the plurality of planes of the first type and each of the plurality of planes of the second type include a plurality of main blocks and an extra block; and a controller configured to control a first extra block to perform an operation command, wherein the plurality of planes of the first type includes the first extra block to which the block address is allocated and the plurality of planes of the second type includes a second extra block to which a block address is not allocated.

A memory system controller according to an embodiment of the present disclosure may include a block address decoder configured to decode a received block address to generate a block selection signal; and a block activator configured to determine, based on the block selection signal, whether to activate a first extra block in a plane of a first type of plane of a memory device, wherein the memory device includes the plane of the first type and a plane of the second type each of which includes a plurality of main blocks and an extra block, the plane of the first type includes the first extra block to which a block address is assigned and the plane of the second type includes a second extra block to which a block address is not assigned.

### BRIEF DESCRIPTION OF THE DRAWINGS

FIG. 1 is a diagram illustrating a memory system according to an embodiment of the present disclosure;

FIG. 2 is a diagram illustrating a memory device according to an embodiment of the present disclosure;

FIG. 3 is a diagram illustrating a memory cell array according to an embodiment of the present disclosure;

FIG. 4A is a diagram illustrating an extra block of a memory cell array having a four-plane structure according to an embodiment of the present disclosure;

FIG. 4B is a diagram illustrating an extra block of a memory cell array having a six-plane structure according to an embodiment of the present disclosure;

FIG. 4C is a diagram illustrating extra blocks of the memory cell array having a six-plane structure according to an embodiment of the present disclosure;

FIG. 4D is a diagram illustrating extra blocks of the memory cell array having a six-plane structure according to an embodiment of the present disclosure;

FIG. 5A is a table showing memory block addresses according to an embodiment of the present disclosure;

FIG. 5B is a table showing memory block addresses according to an embodiment of the present disclosure;

FIG. 6A is a diagram illustrating a block address decoder when the block address decoder receives a main block allocation block address according to an embodiment of the present disclosure;

FIG. 6B is a timing diagram illustrating signals of a block address decoder according to an embodiment of the present disclosure;

FIG. 7A is a diagram illustrating a block address decoder when the block address decoder receives the main block allocation block address according to an embodiment of the present disclosure;

FIG. 7B is a timing diagram illustrating signals of a block address decoder according to an embodiment of the present disclosure;

FIG. 8 is a diagram illustrating a memory card system including a memory device according to an embodiment of the present disclosure; and

FIG. 9 is a diagram illustrating a solid state drive (SSD) system including a memory device according to an embodiment of the present disclosure.

### DETAILED DESCRIPTION

Embodiments of the present disclosure are described in detail with reference to the accompanying drawings. Specific structural or functional descriptions of embodiments are provided as examples to describe concepts that are disclosed in the present application. Examples or embodiments in accordance with the concepts may be carried out in various forms, and the scope of the present disclosure is not limited to the examples or embodiments described in this specification.

Terms such as “first” and “second” are used to distinguish between various components and do not imply size, order, priority, quantity, or importance of the components. For example, a first component may be referred to as a second component in one example, and the second component may be referred to as a first component in another example.

An embodiment of the present disclosure includes a memory system and a controller of the memory system, which may improve storage efficiency of a memory device.

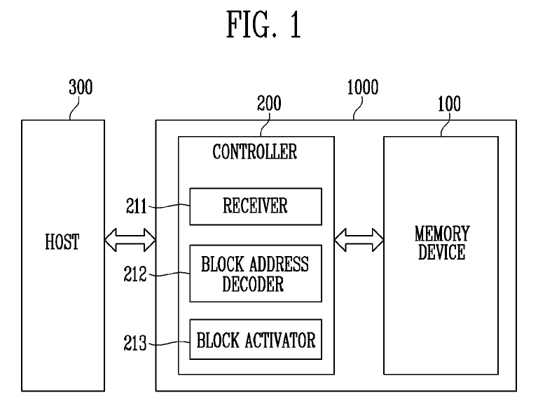

FIG. 1 is a diagram illustrating a memory system 1000 according to an embodiment of the present disclosure.

Referring to FIG. 1, the memory system 1000 includes a memory device 100 and a controller 200. The memory system 1000 communicates with a host 300.

The controller 200 communicates with the host 300 and accesses the memory device 100 in response to a request from the host 300. For example, the controller 200 controls a program operation, a read operation, and an erase operation of the memory device 100.

For example, the controller 200 includes an interface between the memory device 100 and the host 300. The controller 200 drives firmware that controls the memory device 100. For example, the controller 200 receives a host command and a logical address from the host 300 and controls the memory device 100 to perform a corresponding operation.

The controller 200 provides a command and a physical address to the memory device 100. The command transmitted to the memory device 100 is referred to as a “memory command.” The physical address is converted from the logical address. According to the memory command and the physical address, the memory device 100 performs the program operation, the read operation, and the erase operation. For example, the memory device 100 programs data in an area corresponding to the physical address converted from the received logical address, reads the area corresponding to the physical address converted from the received logical address, or erases data from the area corresponding to the physical address converted from the received logical address.

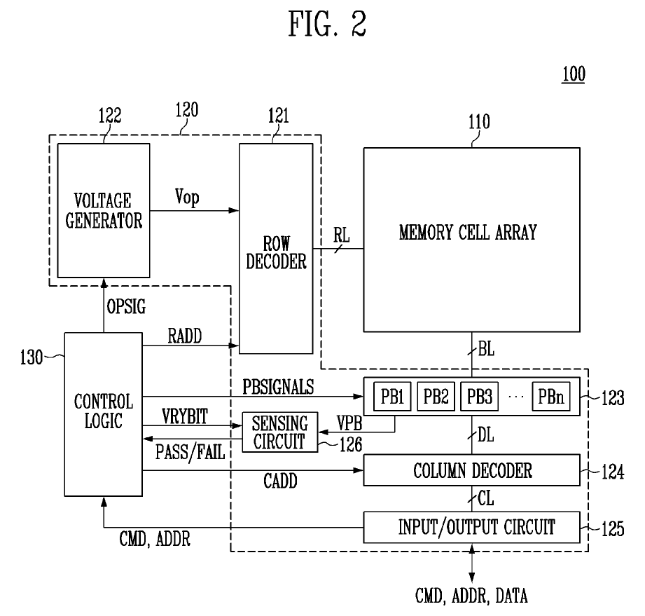

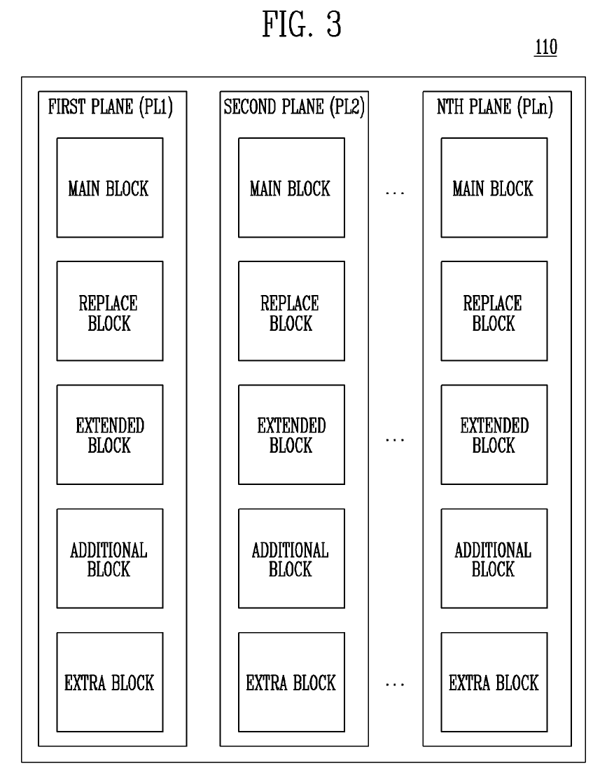

FIG. 2 is a diagram illustrating the memory device 100, for example, as shown in FIG. 1, and FIG. 3 is a diagram illustrating the memory cell array, for example, as shown in FIG. 2.

Referring to FIG. 2 and FIG. 3, the memory device 100 includes a memory cell array 110, a peripheral circuit 120, and control logic 130.

The memory cell array 110 includes a plurality of planes, each of which includes a plurality of memory blocks. The memory block includes a plurality of memory cells, each of which is connected to a row line RL and a bit line BL.

The peripheral circuit 120 is configured to perform the program operation, the read operation, and the erase operation on a selected region of memory cell array 110 under control of the control logic 130. For example, the peripheral circuit 120 applies various operating voltages to the row lines RL and the bit lines BL or selectively discharges the row lines RL and the bit lines BL under control of the control logic 130.

The peripheral circuit 120 includes a row decoder 121, a voltage generator 122, a page buffer group 123, a column decoder 124, an input/output circuit 125, and a sensing circuit 126.

The row decoder 121 is connected to the memory cell array 110 using the row lines RL. The row lines RL include at least one source select line, a plurality of word lines, and at least one drain select line. In an embodiment, the word lines include normal word lines and dummy word lines.

The row decoder 121 is configured to decode a row address RADD received from the control logic 130. The row decoder 121 selects at least one of the memory blocks according to the decoded address. The row decoder 121 transfers operating voltages Vop generated from the voltage generator 122 to the row lines RL of the selected memory block according to the decoded address.

For example, during the program operation, the row decoder 121 applies a program voltage to a selected word line and a program pass voltage at a level lower than the program voltage to unselected word lines. During the program verify operation, the row decoder 121 applies a verify voltage to the selected word line and a verify pass voltage greater than the verify voltage to the unselected word lines. During the read operation, the row decoder 121 applies a read voltage to the selected word line and a read pass voltage greater than the read voltage to the unselected word lines.

The erase operation of the memory device 100 is performed in units of memory blocks. During the erase operation, the row decoder 121 selects one memory block according to the decoded address. During the erase operation, the row decoder 121 applies 0 V or a ground voltage to the word lines coupled to the selected memory block or causes the word lines to float.

The voltage generator 122 operates in response to the control of control logic 130. The voltage generator 122 generates a plurality of voltages using an external power supply voltage supplied to the memory device 100. For example, the voltage generator 122 generates the various operating voltages Vop used for the program operation, the read operation, and the erase operation in response to an operating signal OPSIG generated by the control logic 130. For example, the voltage generator 122 generates a program voltage, a verify voltage, a pass voltage, a read voltage, an erase voltage, and the like in response to control of the control logic 130.

The page buffer group 123 includes first to nth page buffers PB1 to PBn. The first to nth page buffers PB1 to PBn are connected to the memory cell array 110 using corresponding bit lines BL. The first page buffers PB1 to the nth page buffer PBn operate in response to control of the control logic 130. For example, the page buffers PB1 to PBn operate in response to page buffer control signals PBSIGNALS. For example, the page buffers PB1 to PBn temporarily store data received utilizing the corresponding bit lines BL or sense a voltage or current of the corresponding bit lines BL during a read operation or a verify operation.

During the program operation, when the program voltage is applied to the selected word line, the page buffers PB1 to PBn transmit data DATA received from the input/output circuit 125 to the selected memory cells through the bit lines BL. The memory cells of the page selected according to the delivered data DATA are programmed. During the program verify operation, the f page buffers PB1 to PBn sense the voltage or current received from the selected memory cells through the corresponding bit lines BL to read page data.

During the read operation, the page buffers PB1 to PBn read the data DATA from the memory cells of the selected page through the bit lines BL and output the read data DATA to the input/output circuit 125 under control of the column decoder 124.

During the erase operation, the page buffers PB1 to PBn float the corresponding bit lines BL or apply the erase voltage to the corresponding bit lines BL.

The column decoder 124 transfers the data between the input/output circuit 125 and the page buffer group 123 in response to a column address CADD. For example, the column decoder 124 exchanges the data with the page buffers PB1 to PBn through data lines DL or exchanges the data with the input/output circuit 125 through column lines CL.

The input/output circuit 125 transmits a command CMD and an address ADDR, received from the memory controller, to the control logic 130 or may exchange the data DATA with the column decoder 124.

The sensing circuit 126 generates a reference current in response to an allow bit signal VRYBIT during a read operation or a verify operation and compares a sensing voltage VPB received from the page buffer group 123 with a reference voltage generated by the reference current to output a pass signal PASS or a failure signal FAIL.

The control logic 130 outputs the operation signal OPSIG, the row address RADD, the page buffer control signals PBSIGNALS, and the allow bit signal VRYBIT in response to the command CMD and the address ADDR to control the peripheral circuit 120. For example, the control logic 130 controls the read operation of the selected memory block in response to a block read command and the address ADDR. The control logic 130 controls the erase operation of a selected block included in the selected memory block in response to a block erase command and the address ADDR. The control logic 130 determines whether the verify operation is passed or failed in response to the pass signal PASS or the failure signal FAIL.

The control logic 130 includes an address table in which address information is stored for selecting a word line and a bit line based on the address. The address table includes not only address information of main blocks for each plane, but also address information of an extra block to which a block address is allocated among extra blocks. Although user access to the original extra block is limited, when the block address is allocated to an extra block of a certain plane, the block address for the extra block of the corresponding plane is provided in the address table.

Referring to FIG. 3, the memory cell array 110 includes a first plane PL1 to an nth plane PLn. Each of the planes PL1 to PLn includes a main block, a replace block, an extended block, an additional block, and an extra block.

The quantity of each of the main blocks, the replace blocks, the extended blocks, the additional blocks, and the extra blocks included in the memory cell array 110 increases as the memory capacity increases. The quantity of planes included in the memory cell array 110 may also increase as the memory capacity increases.

The main block is a block that stores user data. The replace block is a block that replaces a main block identified as a bad, defective, or unusable block among the main blocks. The extended block is a block that extends the capacity of the main block. The additional block is a block that stores, in the event of a sudden power-off of the memory system, information and data about various operations of the memory currently performed.

The extra blocks may be used as at least one of a Content Addressable Memory (CAM) block and a One-Time Programmable memory (OTP) block. Among the extra blocks, an extra block that is not used as a CAM block may be an unused block. The CAM block is a memory block that stores information utilized during operation of the memory device 100. The information utilized during operation of the memory device 100 may be at least one of information used during operation of the memory device, such as a program start voltage, a program pulse application time, and a read level voltage. The OTP block is a memory block in which protected data information is stored, such as restricted access information, security information, encryption information, fixed data, and so forth.

Referring back to FIG. 1, the controller 200 includes a receiver 211, a block address decoder 212, and a block activator 213.

The receiver 211 receives the command and the address input from the host 300.

For example, the command is an operation command including one of the program command, the read command, and the erase command. The memory block address refers to an address of the main block on which the operation command is executed.

The block address decoder 212 decodes the received block address to generate a block selection signal that selects the memory block.

The block activator 213 determines, based on the block selection signal, whether the decoded block address corresponds to a main block allocation block and activates the extra block based on the result of the determination. The block activator 213 may be configured as a logic circuit. For example, the block activator 213 performs a logical operation on the decoded and output block selection signals using a logical gate and determines whether to activate the block according to a value calculated or determined by the logical operation.

For example, when the decoded block address corresponds to an extra block of the first plane PL1 or the second plane PL2, and the extra block is the main block allocation block to which the main block address is allocated, an extra block activation unit 133 activates the extra block. When the decoded block address is not included in the main block address of the third plane PL3 to the sixth plane PL6, the extra block activation unit 133 does not generate an enable signal.

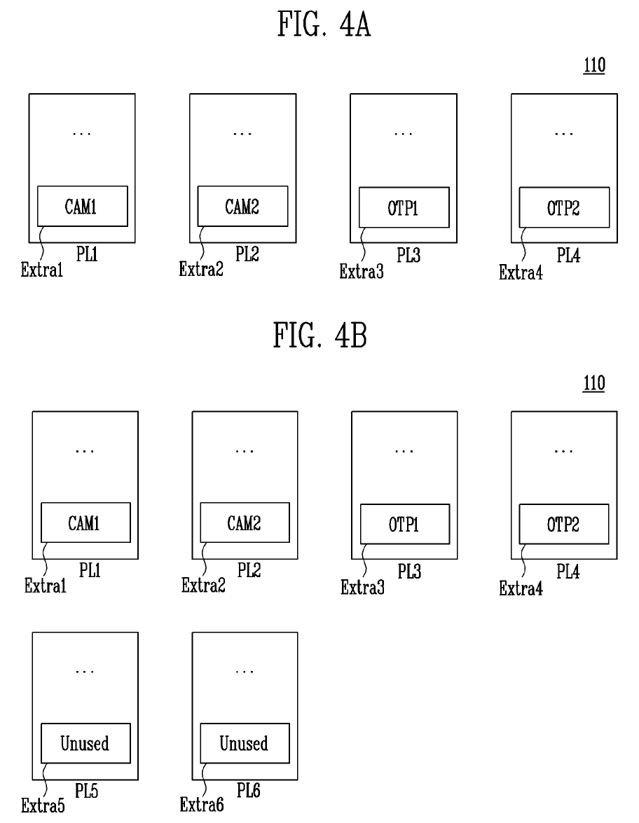

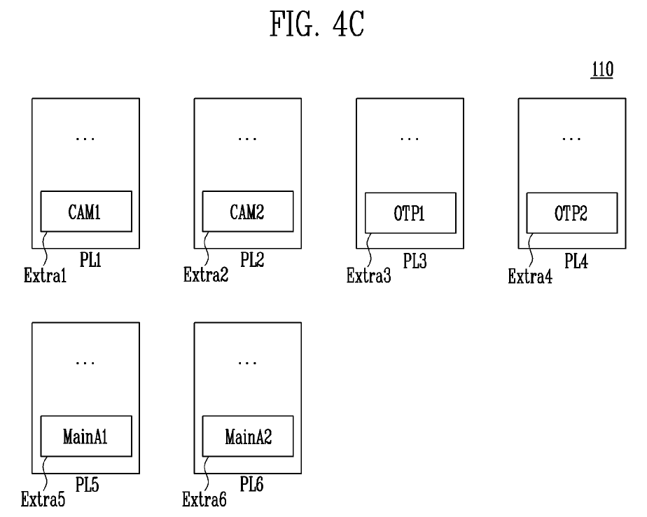

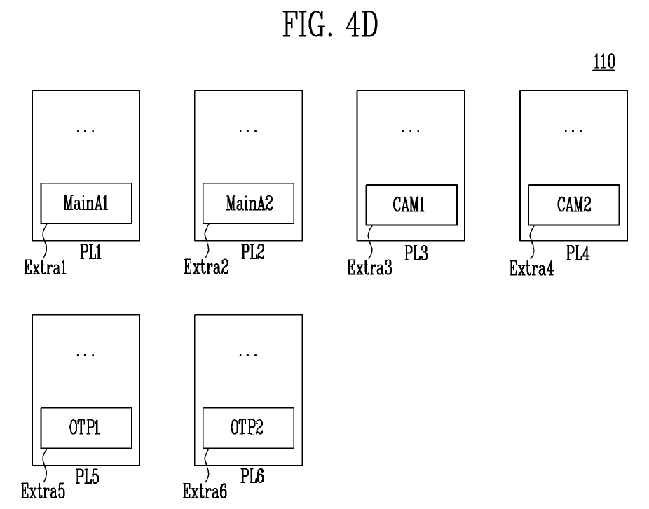

FIG. 4A is a diagram illustrating an extra block of a memory cell array having a four-plane structure according to an embodiment of the present disclosure.

Referring to FIG. 4A, the planes PL1 to PL4 of the memory cell array 110 include a first extra block Extra1 to a fourth extra block Extra4. The first extra block Extra1 of the first plane PL1 is used as a first CAM block CAM1, and the second extra block Extra2 of the second plane PL2 is used as a second cam block CAM2. The third extra block Extra3 of the third plane PL3 is used as a first OTP block OTP1, and a fourth extra block Extra4 of the fourth plane PL4 is used as a second OTP block OTP2.

The memory cell array 110 having the four-plane structure includes four extra blocks Extra1 to Extra4, and the extra blocks Extra block1 to Extra block4 are used as two CAM blocks CAM1 to CAM2 and two OTP blocks OTP1 and OTP2. The memory cell array 110 having a four-plane structure does not include unused extra blocks.

FIG. 4B is a diagram illustrating an extra block of a memory cell array having a six-plane structure according to an embodiment.

Referring to FIG. 4B, the planes PL1 to PL6 of the memory cell array 110 include extra blocks Extra1 to Extra6.

The first extra block Extra1 of the first plane PL1 is used as the first CAM block CAM1, and the second extra block Extra2 of the second plane PL2 is used as the second CAM block CAM2. The third extra block Extra3 of the third plane PL3 is used as the first OTP block OTP1, and the fourth extra block Extra4 of the fourth plane PL4 is used as the second OTP block OTP2.

The fifth extra block Extra5 of the fifth plane PL5 and the sixth extra block Extra6 of the sixth plane PL6 are unused. The memory cell array having the six-plane structure of FIG. 4B has more planes compared to the memory cell array having a four-plane structure of FIG. 4A. The fifth extra block Extra5 of the fifth plane PL5 and the sixth extra block Extra6 are not used as either the CAM block or the OTP block and exist in an unused state. As the quantity of planes increases, the quantity of extra blocks increases in the memory device. Even though the quantity of extra blocks increases, the amount of data stored in the CAM block and the OTP block might not increase. In the memory cell array having the six-plane structure of FIG. 4B, the fifth extra block Extra5 and sixth extra block Extra6 are not used as either the CAM block or the OTP block and exist as unused extra blocks. When an unused extra block exists in a memory cell array having a planar structure, storage efficiency of a memory device is reduced and memory space is wasted.

FIG. 4C is a diagram illustrating extra blocks of a memory cell array having a six-plane structure according to an embodiment.

Referring to FIG. 4C, the planes PL1 to PL6 of the memory cell array 110 include the extra blocks Extra1 to Extra6.

The first extra block Extra1 of the first plane PL1 is used as the first CAM block CAM1, and the second extra block Extra2 of the second plane PL2 is used as the second CAM block CAM2. The third extra block Extra3 of the third plane PL3 is used as the first OTP block OTP1, and the fourth extra block Extra4 of the fourth plane PL4 is used as the second OTP block OTP2.

The fifth extra block Extra5 of the fifth plane PL5 and the sixth extra block Extra6 of the sixth plane PL6 are not unused. The fifth extra block Extra5 of the fifth plane PL5 is used as a first main block allocation block MainA1, and a sixth extra block Extra6 of the sixth plane PL6 is used as a second main block allocation block MainA2. The fifth and sixth planes PL5 and PL6, where the main block allocation blocks are located, are referred to as a first type of plane, and the first to fourth planes PL1 to PL4 where the main block allocation blocks do not exist, are referred to as a second type of plane. As the quantity of planes increases, the quantity of extra blocks increases. When the main block address is allocated to the extra block that is not used as a CAM block or an OTP block, the extra block is used as a memory space that stores user data. In this example, the settings of the first type of plane and the settings of the second type of plane may be specified by the user or may be specified in advance by the manufacturer, for example, before being provided to the user.

FIG. 4D is a diagram illustrating extra blocks of a memory cell array having a six-plane structure according to an embodiment.

Unlike the memory cell array in FIG. 4C, the memory cell array of FIG. 4D allocates the extra block used as the main block allocation block to a plane having a faster index than the index of FIG. 4C.

Referring to FIG. 4D, the planes PL1 to PL6 of the memory cell array 110 include extra blocks Extra1 to Extra6.

The first extra block Extra1 of the first plane PL1 is used as the first main block allocation block MainA1, and the second extra block Extra2 of the second plane PL2 is used as the second main block allocation block MainA2.

The first plane PL1 and the second plane PL2 where the main block allocation block exists is referred to as a first type of plane, and the third plane PL3 to the sixth plane PL6 where the main block allocation block does not exist are referred to a second type of plane.

The planes PL1 to PL6 may be sequentially indexed. For example, the first type of planes PL1 and PL2 may have a faster index than the second type of planes PL3 to PL6. When the first type of planes PL1 and PL2 have the faster index than the second type of planes PL3 to PL6, the memory space that stores user data in the information of the memory system provided to the user may be represented as a continuous data area.

The third extra block Extra3 of the third plane PL3 is used as the first CAM block CAM1, and the fourth extra block Extra4 of the fourth plane PL4 is used as the second CAM block CAM2. The fifth extra block Extra5 of the fifth plane PL5 is used as the first OTP block OTP1, and the sixth extra block Extra6 of the sixth plane PL6 is used as the second OTP block OTP2.

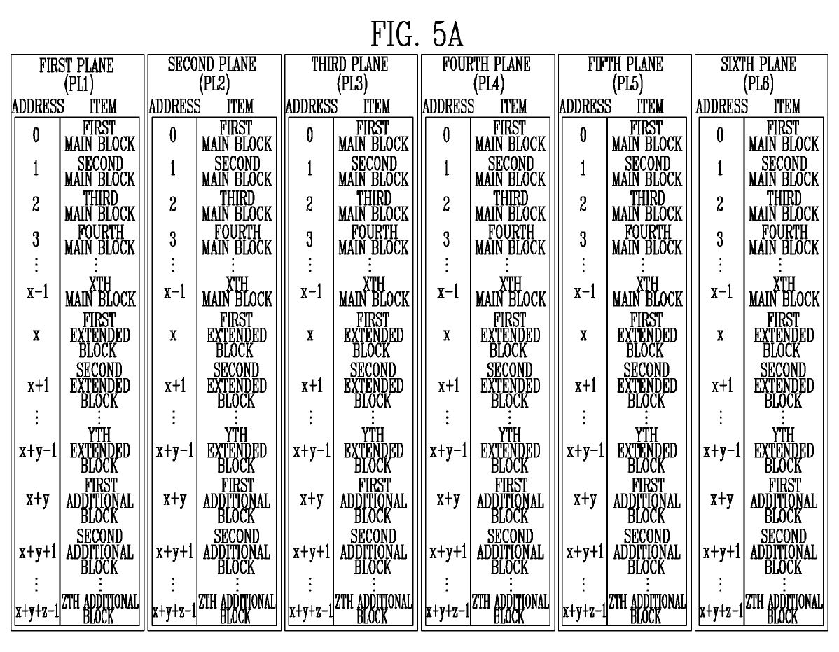

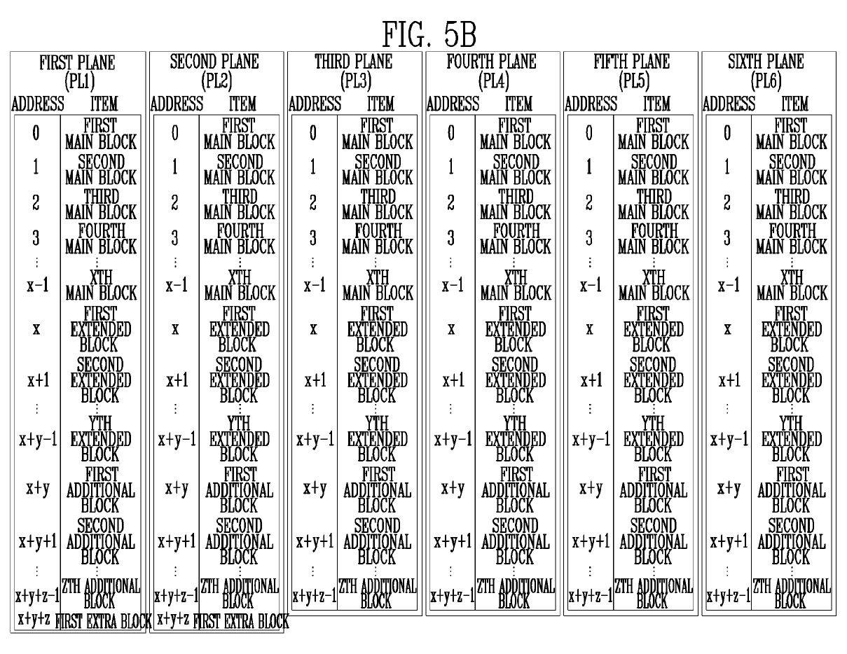

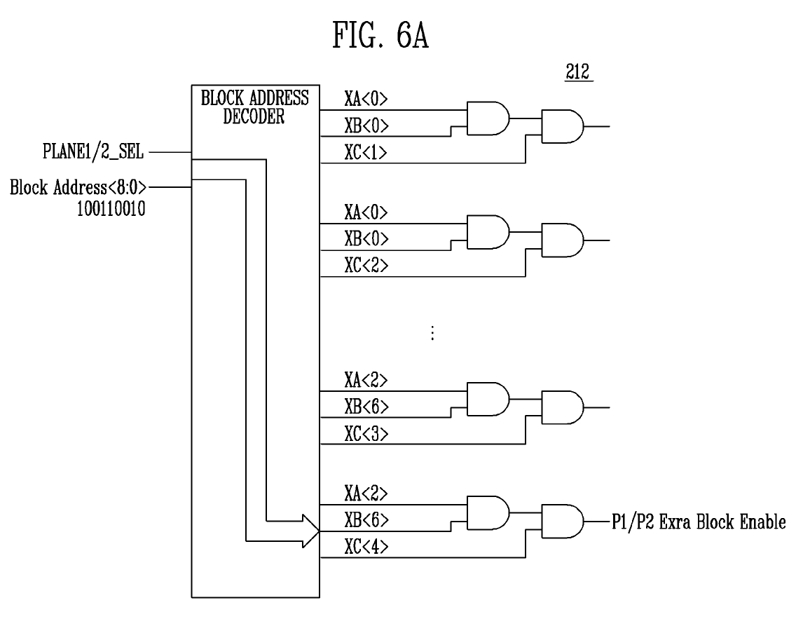

FIG. 5A is a table showing memory block addresses for various planes, for example, according to FIG. 4B.

Referring to FIG. 5A, the memory block addresses for each of the plurality of planes PL1 to PL6 include addresses for a plurality of main blocks, addresses for a plurality of extended blocks, addresses for a plurality of additional blocks, and addresses for the extra blocks.

The addresses of the first plane PL1 are described as representative of addresses of the plurality of planes PL1 to PL6. The addresses of each of the planes PL2 to PL6 are assigned similarly to the addresses of the first plane PL1.

The first plane PL1 includes the plurality of main blocks, a plurality of replace blocks, the plurality of extended blocks, the plurality of additional blocks, and the extra block. The address of the memory block may be assigned only to memory blocks accessible to the user. Thus, the user might not access the replace block and the extra block among the memory blocks, and the memory block addresses for the replace block and/or the extra block may not be allocated. Therefore, the address for the memory block of the first plane PL1 may be sequentially allocated to the plurality of main blocks, the plurality of extended blocks, and the plurality of additional blocks, which are memory blocks accessible to the user in an embodiment.

In this example, the memory device has a six-plane structure, and the quantity of each of the plurality of main blocks, the quantity of the plurality of extended blocks, and the quantity of the plurality of additional blocks of the first plane PL1 are x, y, and z, respectively. The addresses of a first main block, a second main block, a third main block, a fourth main block, …, and a xth main block are 0, 1, 2, 3, …, and x-1, respectively. The addresses of a first extended block, a second extended block, …, and an yth extended block are x, x+1, …, and x+y−1, respectively. The addresses of a first additional block, a second additional block, …, and a zth additional block are x+y, x+y+1, …, and x+y+z−1, respectively.

In an embodiment, the first plane PL1 has 273 main blocks, 7 extended blocks, and 26 additional blocks. An address of the first main block is 0, an address of the 273rd main block is 272, an address of the first extended block is 273, an address of the 7th extended block is 279, an address of the first additional block is 280, and an address of the 26th additional block is 305 in this example.

FIG. 5B is a table showing memory block addresses, for example, according to FIG. 4D.

Referring to FIG. 5B, the memory block addresses for the planes PL1 and PL2 include the addresses for the plurality of main blocks, the addresses for the plurality of extended blocks, the addresses for the plurality of additional blocks, and the addresses for the extra blocks.

The memory block addresses for planes PL3 to PL6 include the addresses for the plurality of main blocks, the addresses for the plurality the extended blocks, the addresses for the plurality of additional blocks, and the addresses for the extra blocks. User access to the replace blocks and used extra blocks among the addresses of the memory blocks may not be possible in an embodiment.

In the embodiment according to FIG. 5B, the addresses of the memory block are allocated to the memory block accessible to the user and to the extra blocks that are not accessible to the user.

The extra blocks of the planes PL1 to PL4 are used as CAM blocks and OTP blocks, although use of the extra blocks of the planes PL3 to PL6 as the CAM blocks and the OTP blocks may advantageously provide continuous memory block information capable of storing user data.

Each of the planes PL1 to PL6 includes one extra block. In the example of a conventional four-plane structure, the extra blocks of the planes PL1 and PL2 are used as CAM blocks, and the extra blocks of the planes PL3 and PL4 are used as OTP blocks. In the example of FIG. 5B, as block addresses are assigned to the corresponding extra blocks of PL1 and PL2, the extra blocks are shown in the table displaying the memory block addresses.

To increase the capacity of the memory device, when the quantity of extra blocks increases due to an increase in the quantity of planes and the data capacity used for the CAM block and the OTP block does not increase significantly, additional use of the extra blocks is not involved. Therefore, in a memory device having a structure of six or more planes, an unused extra block may be present in the planes PL5 and PL6.

The addresses for memory blocks of the planes PL1 to PL6 that are accessible to the user may be allocated sequentially for the plurality of main blocks, the plurality of extended blocks, and the plurality of additional blocks in an embodiment.

For example, in the memory device having a six-plane structure, the quantity of the plurality of main blocks, the quantity of the plurality of extended blocks, and the quantity of the plurality of additional blocks of the planes PL1 and PL2 are x, y, and z, respectively. The addresses of the first main block, the second main block, the third main block, the fourth main block, …, and the xth main block is 0, 1, 2, 3, …, and x-1, respectively. The addresses of the first extended block, the second extended block, …, and the yth extended block are x, x+1, x+2, …, and x+y−1, respectively. The addresses of the first additional block, the second additional block, and the zth additional block are x+y, x+y+1, …, and x+y+z−1, respectively. The address of the extra block is the last block address among the block addresses allocated to the blocks. Thus, the address of the extra block is x+y+z.

For example, each of the planes PL1 and PL2 has 273 main blocks, 7 extended blocks, 26 additional blocks, and 1 extra block. The address of the 273rd main block is 272, the address of the 7th extended block is 279, the address of the 26th additional block is 305, and the address of the extra block is 306.

In an embodiment of the memory device having a six-plane structure, the quantity of the plurality of main blocks, the quantity of the plurality of extended blocks, and the quantity of the plurality of additional blocks in each of the planes PL3 to PL6 is x, y, and z, respectively. The addresses of the first main block, the second main block, the third main block, the fourth main block, …, and the xth main block are 0, 1, 2, 3, …, and x-1, respectively. The addresses of the first extended block, the second extended block, …, and the yth extended block are x, x+1, x+2, …, and x+y−1, respectively. The addresses of the first additional block, the second additional block, and the zth additional block are x+y, x+y+1, …, and x+y+z−1, respectively.

For example, in an embodiment, each of the planes PL1 and PL2 has 273 main blocks, 7 extended blocks, 26 additional blocks, and 1 extra block. The address of the 273rd main block is 272, the address of the 7th extended block is 279, and the address of the 26th additional block is 305.

To prevent the extra block that is additionally generated and has a predetermined role from being unused as the quantity of planes increases, the block address is allocated to the unused extra block of one or more planes. For example, according to the present disclosure, the extra block of one or more planes is assigned to an address obtained by adding 1 to the last address of the block addresses of the main blocks. Accordingly, the physical logic circuit configuration added to the block address decoder 212 in FIG. 1 may be simplified while minimizing software changes.

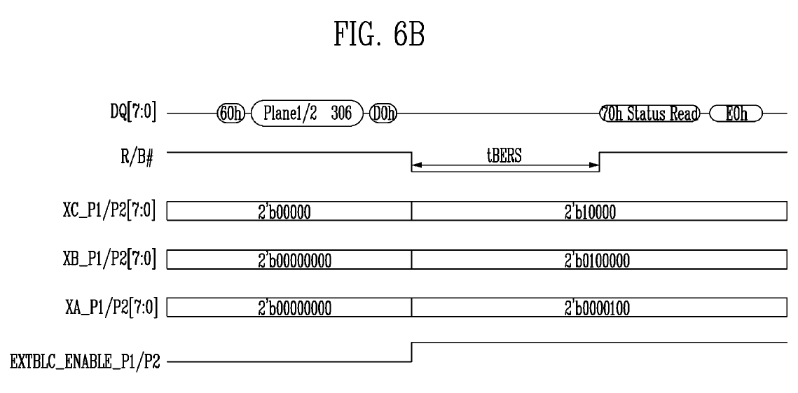

FIG. 6A is a diagram illustrating a block address decoder when the block address decoder receives the main block allocation block address of a plane in which an extra block is used as a main block allocation block, and FIG. 6B is a timing diagram illustrating signals of a block address decoder, for example, according to FIG. 6A.

Referring to FIG. 6A and FIG. 6B, the block address decoder 212 receives a plane and a block address.

In FIG. 6A, the block address decoder 212 receives a PLANE1/2_SEL signal indicating identification information of the plane and a 9-bit block address <8:0> signal indicating the 306 block address.

Although the plane information P1/P2 included in the signal information is grouped for convenience, the actual signal name refers to one of the planes P1 or P2.

For example, the plane information P1/P2 is configured for either of the planes PL1 and PL2 that are the first type of plane in which the extra blocks exist as the accessible main block allocation block. Thus, EXTBLC_ENABLE_ P1/P2 is P1 Extra Block Enable when referring to the first extra block enable of the first plane PL1, or P2 Extra Block Enable when referring to the second extra block enable of the second plane PL2.

Because the last main block address among the main block addresses is 305, the block address of the first extra block is 306 obtained by adding 1 to the last block address. In this example, the block address 306 of the first extra block is represented by a binary number 100110010. When 100110010 is divided into 3-bit groups, the first group is 4 (2’b100), the second group is 6 (2’b110), and the third group is 2 (2’n010), which are XC<4>, XB<6>, and XA<2>. The logic circuit generates the signal of the first extra block enable P1 Extra block Enable based on each signal of XC<4>, XB<6>, and XA<2>.

When the block address includes 9 bits, input values obtained by dividing the block address into 3-bit groups are input to an AND gate and an enable signal is generated. Alternative quantities of bits may be utilized. The block address decoder 212 generates the enable signal for the first extra block when the address received from the host 300 in FIG. 1 is identified as the first extra block for the first type of plane such as PL1 and PL2.

The present disclosure customizes only specific planes among multiple planes by assigning a block address to an extra block, leaving other planes unchanged. In an embodiment, a logic circuit is added to receive signals XC<4>, XB<6>, and XA<2> corresponding to block address 306 and outputs the enable signal to logic circuits that receive signals XC<0>, XB<0>, and XA<0> to XC<4>, XB<6>, and XA<1> and outputs the enable signal. In FIG. 6B, when an erase setup command 60h is received for a block address 306 in Plane 1 or Plane 2, since a block address is also assigned to the corresponding address 306 in Plane 1 or Plane 2, EXBLC_ENABLE_P1 or EXBLC_ENABLE_P2 may be activated by the logic gate in FIG. 6A. Thus, according to the present disclosure, by using the logic circuit that receives signals XC<4>, XB<6>, and XA<2> and outputs the enable signal, the extra block may be used as the main block while minimizing or reducing software modification.

The control logic 130 of FIG. 2 performs one of the program operation, the read operation, and the erase operation on the extra block corresponding to the selected address.

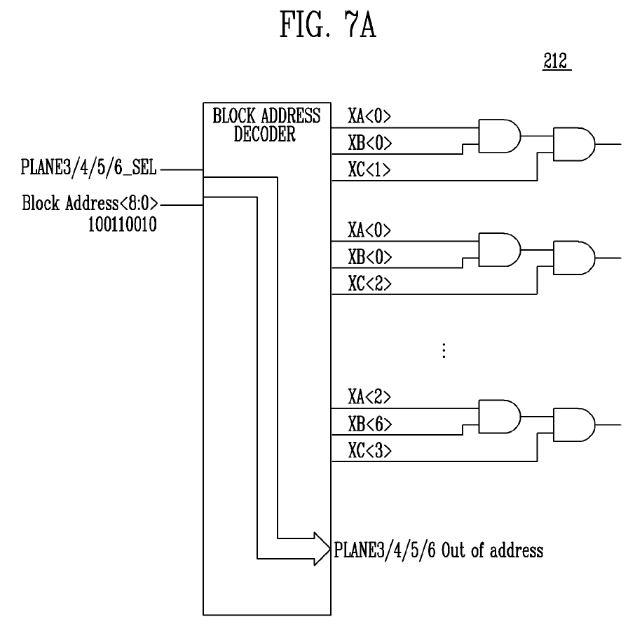

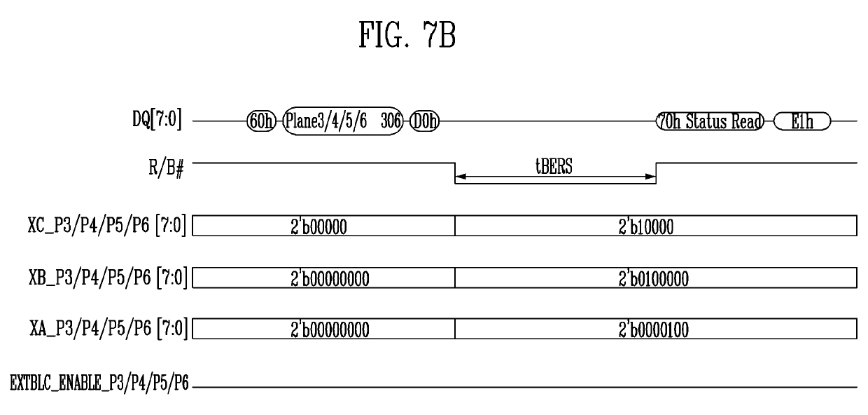

FIG. 7A is a diagram illustrating a block address decoder when the block address decoder receives the main block allocation block address of the corresponding plane in the example of a plane in which an extra block is not used as a main block allocation block, and FIG. 7B is a timing diagram showing signals of a block address decoder, for example, according to FIG. 7A.

Although the plane information P3/P4/P5/P6 included in the signal information is grouped for convenience, the actual signal name refers to one of the planes P3, P4, P5, or P6.

For example, PLANE3/4/5/6_SEL refers to one of PLANE3_SEL, PLANE4_SEL, PLANE5_SEL, and PLANE6_SEL. The signals PLANE3_SEL, PLANE4_SEL, PLANE5_SEL, and PLANE6_SEL refer to a signal selecting the third plane PL3, a signal selecting the fourth plane PL4, a signal selecting the fifth plane PL5, and a signal selecting the sixth plane PL6. Each of PLANE3, PLANE4, PLANE5, and PLANE6 is the second type of plane and refers to the third plane PL3 to the sixth plane PL6.

For example, EXTBLC_ENABLE_P3/P4/P5/P6 or P3/P4/P5/P6 Extra Block Enable refers to one of EXTBLC_ENABLE_P3, EXTBLC_ENABLE_P4, EXTBLC_ENABLE_P5, or EXTBLC_ENABLE_P6. The signal is one of an extra block enable signal of the third plane PL3, an extra block enable signal of the fourth plane PL4, an extra block enable signal of the fifth plane PL5, and an extra block enable signal of the sixth plane PL6.

Referring to FIG. 7A and FIG. 7B, the block address decoder 212 receives one of input signals PLANE3_SEL, PLANE4_SEL, PLANE5_SEL, or PLANE6_SEL indicating identification information of the plane and the 9-bit block address <8:0> 100110010 signal indicating the block address 306.

The last block address among the block addresses is 305, and the received address 306 is out of the range of 0 to 305. In an embodiment, user access to the extra block is restricted. Therefore, when the decoded address in one of the planes PL3 to PL6, which is a plane of the second type, is XC<4>, XB<6>, XA<2>, no blocks are selected by the block address decoder. Because no logic circuits correspond to XC<4>, XB<6>, and XA<2>, no enable signals are generated in the block address decoder 212, as in FIG. 7B, and a ready-busy R/B signal is activated for a short time tBERS and subsequently deactivated. In FIG. 7B, when an erase setup command 60h is received for block address 306 in Plane 3, Plane 4, Plane 5 or Plane 6, because a block address is not assigned to the corresponding address 306 in in Plane 3, Plane 4, Plane 5 and Plane 6, when a status read operation 70h is requested for the block, the block is treated as a bad, defective, or unusable block.

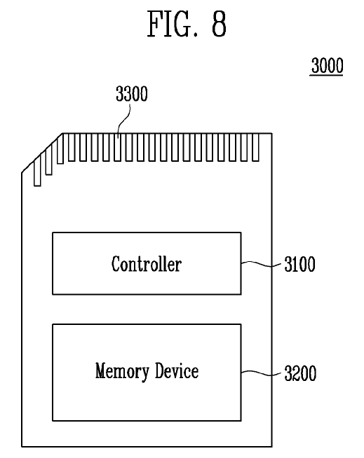

FIG. 8 is a diagram illustrating a memory card system including the memory device according to an embodiment of the present disclosure.

Referring to FIG. 8, a memory card system 3000 includes a controller 3100, a memory device 3200, and a connector 3300.

The controller 3100 is connected to the memory device 3200. The controller 3100 is configured to access the memory device 3200. For example, the controller 3100 is configured to control a program operation, a read operation, and an erase operation of the memory device 3200 or to control a background operation. The controller 3100 is configured to include an interface between the memory device 3200 and a host. The controller 3100 is configured to run firmware that controls the memory device 3200. For example, the controller 3100 may include components such as a Random Access Memory (RAM), a processing unit, a host interface, a memory interface, and an error correction unit.

The controller 3100 communicates with an external device through the connector 3300. The controller 3100 communicates with the external device, for example, a host, according to specific communication protocols. For example, the controller 3100 is configured to communicate with an external device via at least one of a variety of communication standards or interfaces, such as a Universal Serial Bus (USB), a multimedia card (MMC), an embedded MMC (eMMC), a peripheral component interconnect (PCI), a PCI-express (PCI-E), Advanced Technology Attachment (ATA), Serial-ATA, Parallel-ATA, a small computer system interface (SCSI), an enhanced small disk interface (ESDI), Integrated Drive Electronics (IDE), Firewire, Universal Flash Storage (UFS), WiFi, Bluetooth, or NonVolatile Memory express (NVMe). For example, the connector 3300 may be configured according to at least one of these communication standards or interfaces.

The memory device 3200 includes memory cells and may be configured similarly to the memory device 100 of FIG. 1, including an extra block as described, for example, with respect to FIG. 3, FIG. 4A to FIG. 4D, FIG. 5A, and FIG. 5B.

The controller 3100 and the memory device 3200 are integrated into one semiconductor device within a memory card. For example, the controller 3100 and the memory device 3200 may be integrated into one semiconductor device within a memory card such as a Personal Computer Memory Card International Association (PCMCIA) memory card, a Compact Flash (CF) card, a smart media card (SM, SMC), a memory stick, a multimedia card (MMC, RS-MMC, MMCmicro, eMMC), Secure Digital (SD) card (SD, miniSD, microSD, SDHC), or a Universal Flash Storage (UFS) device.

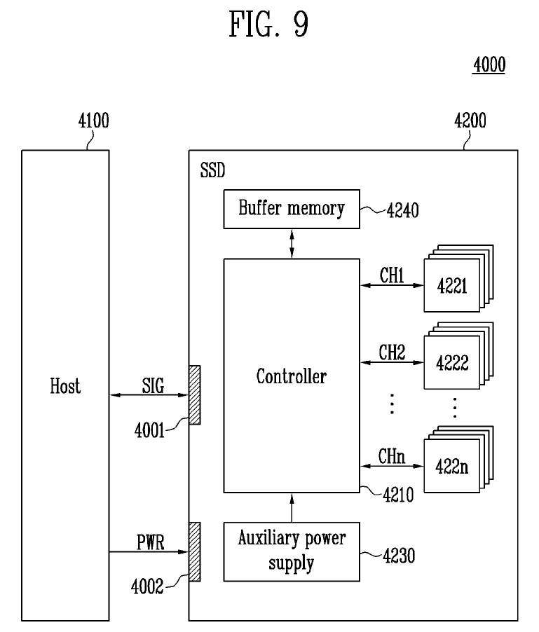

FIG. 9 is a diagram illustrating a Solid-State Drive (SSD) system 4000 including a memory device according to an embodiment of the present disclosure.

Referring to FIG. 9, the SSD system 4000 includes a host 4100 and an SSD 4200. The SSD 4200 exchanges a signal SIG with the host 4100 through a signal connector 4001 and receives power PWR through a power connector 4002. The SSD 4200 includes a controller 4210, a plurality of memory devices 4221 to 422n, an auxiliary power supply 4230, and buffer memory 4240.

The controller 4210 may control the plurality of memory devices 4221 to 422n in response to the signal received from the host 4100. For example, the signal may be based on an interface of the host 4100 and the SSD 4200. For example, the signal may be described by at least one interface such as Universal Serial Bus (USB), multimedia card (MMC), embedded MMC (eMMC), peripheral component interconnect (PCI), PCI-express (PCI-E), Advanced Technology Attachment (ATA), Serial-ATA, Parallel-ATA, small computer system interface (SCSI), enhanced small disk interface (ESDI), Integrated Drive Electronics (IDE), Firewire, Universal Flash Storage (UFS), WiFi, Bluetooth, and NVMe interfaces.

The plurality of memory devices 4221 to 422n includes cells capable of storing data. Each of the plurality of memory devices 4221 to 422n is configured similarly to the memory device 100 of FIG. 1, including an extra block as described, for example, with respect to FIG. 3, FIG. 4A to FIG. 4D, FIG. 5A, and FIG. 5B.

The auxiliary power supply 4230 is connected to the host 4100 through the power connector 4002. The auxiliary power supply 4230 receives power from the host 4100 and may be recharged. The auxiliary power supply 4230 provides the power voltage of the SSD 4200 when the power supply from the host 4100 is not clean or smooth. For example, the auxiliary power supply 4230 is located in the SSD 4200 or located outside the SSD 4200. For example, the auxiliary power supply 4230 may be located on a main board and may provide auxiliary power to the SSD 4200.

The buffer memory 4240 operates as buffer memory of the SSD 4200. For example, the buffer memory 4240 temporarily stores data received from the host 4100 or data received from the plurality of memory devices 4221 to 422n or temporarily stores metadata, such as a mapping table, of the memory devices 4221 to 422n. The buffer memory 4240 may include volatile memory such as DRAM, SDRAM, DDR SDRAM, or LPDDR SDRAM or non-volatile memory such as FRAM, ReRAM, STT-MRAM, or PRAM.

According to embodiments of the present disclosure, waste of a memory space may be prevented and storage efficiency of a memory system may be improved by allocating a main block address to an unused extra block in a memory device and using the extra block as a main block.

Concepts are disclosed in conjunction with examples and embodiments. Those skilled in the art will understand that various modifications, additions, combinations, and substitutions are possible without departing from the scope and technical concepts of the present disclosure. The embodiments disclosed in the present specification should be considered from an illustrative standpoint and not a restrictive standpoint. Therefore, the scope of the present disclosure is not limited to these descriptions. All changes within the meaning and range of equivalency of the claims are included within their scope.

What is claimed is:

1. A memory system comprising:
a memory device including a plurality of planes of a first type and a plurality of planes of a second type, wherein each of the plurality of planes of the first type and each of the plurality of planes of the second type include a plurality of main blocks and an extra block; and
a controller configured to control a first extra block to perform an operation command, wherein the first extra block is included in the plurality of planes of the first type and to which a block address is allocated;
wherein the plurality of planes of the first type includes the first extra block to which the block address is allocated and the plurality of planes of the second type of plane includes a second extra block to which a block address is not allocated.

2. The memory system of claim 1, wherein the last block address allocated to the plurality of planes of the first type is allocated to the first extra block.

3. The memory system of claim 1, wherein the second extra block included in the plurality of planes of the second type is one of a One-Time Programmable memory (OTP) block and a Content Addressable Memory (CAM) block.

4. The memory system of claim 1, wherein the plurality of planes of the first type and the plurality of planes of the second type are indexed sequentially; and
wherein the plurality of planes of the first type has an index faster than the plurality of planes of the second type.

5. The memory system of claim 1, wherein the controller generates an enable signal that activates the first extra block when an address received from a host is the block address of the plurality of planes of the first type and is allocated to the first extra block.

6. The memory system of claim 5, wherein the controller includes a first logic circuit that generates the enable signal for the first extra block.

7. The memory system of claim 3, wherein the controller is configured not to select a main block when a block address received from a host is the block address of the plurality of planes of the second type and addresses the second extra block.

8. The memory system of claim 1, wherein the controller comprises a block address decoder configured to decode a received block address to generate a block selection signal.

9. The memory system of claim 1, wherein the operation command comprises a program command, a read command, and an erase command on the first extra block.

10. The memory system of claim 1, wherein the block address includes 9 bits and the 9 bits are divided into 3-bit groups input as an input signal to a logic circuit.

11. A controller of a memory system, the controller comprising:
a block address decoder configured to decode a received block address to generate a block selection signal; and
a block activator configured to determine, based on the block selection signal, whether to activate a first extra block in a plane of a first type of plane of a memory device;
wherein the memory device includes the plane of the first type and a plane of a second type, each of the plane of the first type and the plane of the second type includes a plurality of main blocks and an extra block, the plane of the first type includes the first extra block to which a block address is assigned, and the plane of the second type includes a second extra block to which a block address is not assigned.

12. The controller of the memory system of claim 11, wherein the last block address allocated to the plane of the first type is allocated to the first extra block.

13. The controller of the memory system of claim 11, wherein the second extra block included in the plane of the second type is one of a One-Time Programmable memory (OTP) block and a Content Addressable Memory (CAM) block.

14. The controller of the memory system of claim 11, wherein the plane of the first type and the plane of the second type are indexed sequentially; and
wherein the plane of the first type has an index faster than the plane of the second type.

15. The controller of the memory system of claim 11, wherein, when an address received from a host is associated with the plane of the first type and the block address is assigned to the first extra block, an enable signal is generated to activate the first extra block.

16. The controller of the memory system of claim 15, wherein the block activator comprises a first logic circuit that generates the enable signal for the first extra block.

17. The controller of the memory system of claim 13, wherein, when the block address received from a host is the block address of the plane of the second type and addresses the second extra block, a main block is not selected.

18. The controller of claim 11, wherein the memory system comprises a block address decoder configured to decode a received block address to generate a block selection signal.

19. The controller of the memory system of claim 11, wherein the operation command comprises a program command, a read command, and an erase command on the first extra block.

20. The controller of the memory system of claim 11, wherein the block address includes 9 bits and the 9 bits are divided into 3-bit groups input as an input signal to a logic circuit.
